(19) United States
(12) Patent Application Publication
(10) Pub. No.: US 2012/0254462 A1
(43) Pub. Date: Oct. 4, 2012

(54) REMOTE DATA MIRRORING USING A VIRTUALIZED IO PATH IN A SAS SWITCH

(76) Inventors: Dhishankar Sengupta, Bangalore (IN); Mahmoud K. Jibbe, Wichita, KS (US); Senthil Kannan, Pondicherry (IN); Britto Rossario, Bangalore (IN)

(21) Appl. No.: 13/076,578

(22) Filed: Mar. 31, 2011

(51) Int. Cl. G06F 15/173

(52) U.S. Cl. 709/238

(57) ABSTRACT

An apparatus comprising a first switch and a second switch. The first switch may include a first plurality of ports, where a first of the ports is connected to a first host device, a second of the ports is connected to a first target device, and a third of the ports is connected to a network. The first target device may include a first storage LUN. The second switch may include a second plurality of ports, where a first of the ports is connected to a second host device, a second of the ports is connected to a second target device, and a third of the ports is connected to the network. The second target device may include a second storage LUN. The first storage LUN and the second storage LUN form a data mirror.

### FIELD OF THE INVENTION

The present invention relates to data storage generally and, more particularly, to a method and/or apparatus for implementing remote data mirroring using a virtualized I/O path in a SAS switch.

### BACKGROUND OF THE INVENTION

Conventional storage systems do not support remote mirroring of Serial Attached SCSI (SAS) storage array controllers. In a local mirror operation, the input/output (I/O) path residing inside the SAS storage array controller implements the input/output mirroring. Such mirroring creates overhead to the controller input/output operations and can add to the performance bottleneck in large storage infrastructures.

It would be desirable to implement a system and method for remote data mirroring using a virtualized input/output path in a SAS switch.

### SUMMARY OF THE INVENTION

The present invention concerns an apparatus comprising a first switch and a second switch. The first switch may include a first plurality of ports, where a first of the ports is connected to a first host device, a second of the ports is connected to a first target device, and a third of the ports is connected to a network. The first target device may include a first storage LUN. The second switch may include a second plurality of ports, where a first of the ports is connected to a second host device, a second of the ports is connected to a second target device, and a third of the ports is connected to the network. The second target device may include a second storage LUN. The first storage LUN and the second storage LUN form a data mirror.

The objects, features and advantages of the present invention include providing a system and method for remote data mirroring using a virtualized I/O path in a SAS switch that may (i) perform LUN mirroring of I/O block processing at an IOV layer in the SAS switch, (ii) act as a virtual target to an actual host and/or as a virtual initiator to an actual target; (iii) provide dedicated mirror ports in the SAS switch, (iv) provide dedicated mirror ports in the SAS switch capable of multi-protocol routing, (v) be discovered and configured for remote volume/LUN mirroring through multiprotocol convertor ports, (vi) provide volume/LUN mirroring to a SAS storage array connected locally to the same SAS switch or to a remote SAS storage array connected to a remote SAS switch through the dedicated mirror ports, (vii) be configured as a redundant SAS switch for another intelligent SAS switch, (viii) provide redundancy in the SAS switch, (ix) reduce the load on an SAS storage controller needed to process the volume/LUN mirror, (x) provide remote volume/LUN mirror capability in SAS storage array controllers, (xi) provide redundancy at the SAS switch level for disaster recovery, (xii) provide LUN mirroring at the same storage array and also at a different array (e.g., a remote or local array) and/or (xiii) provide local mirroring within a fixed distance in the same location using active port functionality on the SAS switch.

### BRIEF DESCRIPTION OF THE DRAWINGS

These and other objects, features and advantages of the present invention will be apparent from the following detailed description and the appended claims and drawings in which:

FIG. 1 is a block diagram illustrating a context of the present invention;

FIG. 2 is a diagram of a switch in accordance with the present invention;

FIG. 3 is a more detailed diagram illustrating a further context of the present invention;

FIG. 4 is a diagram illustrating the process of creating a routing table; and

FIG. 5 is a flow diagram illustrating the process of handing input/output.

### DETAILED DESCRIPTION OF THE PREFERRED EMBODIMENTS

Storage virtualization separates the logical representation of data storage from the physical storage components. By provisioning storage at the SAS switch level, the present invention may enable high availability and/or scalability and/or provide substantial improvement in managing a variety of storage arrays. The present invention may be implemented as part of a Serial Attached SCSI (SAS) storage array controller, or as a stand alone application. In one embodiment, a device may be implemented to operate in a heterogeneous environment. The heterogenous environment may include servers and/or storage devices from various vendors. Storage may be flexibly allocated to the servers and/or storage applications through a software program on the SAS switch.

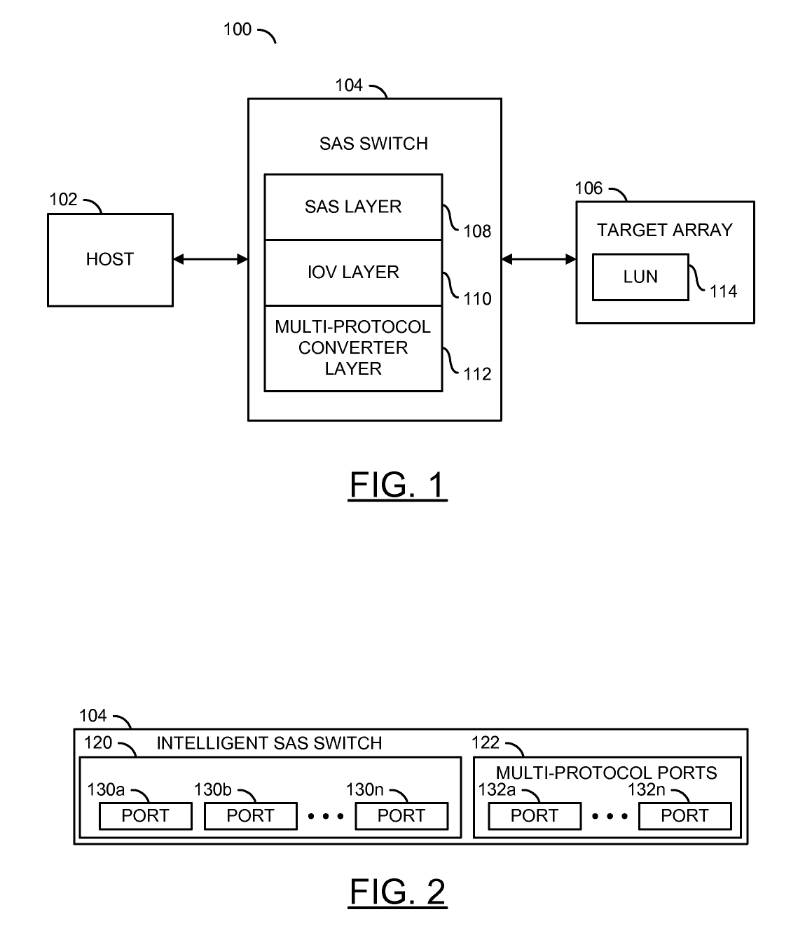

Referring to FIG. 1, a block diagram of a system 100 is shown illustrating a context of the present invention. The system 100 generally comprises a block (or circuit) 102, a block (or circuit) 104 and block (or circuit) 106. The circuit 104 may comprise a block (or circuit) 108, a block (or circuit) 110 and a block (or circuit) 112. The circuit 106 may comprise a block (or circuit) 114. The block 102 may be implemented as a host (or initiator). The block 104 may be implemented as a SAS switch. The block 106 may be implemented as a target array. The block 108 may be implemented as a SAS layer. The block 110 may be implemented as an input/output virtualization (IOV) layer. The block 112 may be implemented as a multi-protocol converter layer. The block 114 may be implemented as one or more LUNs.

The intelligent SAS switch 104 may implement initiator, target and/or logical unit operations. In one example, the switch 104 may implement Initiator Target LUN (ITL) nexus operations. The switch 104 may act as a virtual initiator to one or more physical SAS targets (e.g., the target array 106). Each device in a network (e.g., SCSI, FC, SAS, iSCSI, etc.) may have an ITLX nexus, where X is a queue ID. The switch 104 may also operate as a virtual target for one or more physical hosts. The IOV layer 110 may be linked to the target array 106 through a hardware abstract layer (e.g., an Interlink Layer) located in the SAS layer 108. The target array 106 may be implemented as any SAS physical target.

The system 100 may include an intelligent SAS switch 104 implementing an input/output (I/O) data path virtualization layer linked to one or more SAS storage array controllers (e.g., the target array 106) through interlink layers 108, 110 and/or 112. The I/O path virtualization layer may implement host side LUN mapping and/or other mapping to connect one or more LUNs (e.g., the LUN 114) to one or more hosts (e.g. the host 102). A LUN may refer to a logical unit number that may represent a volume formed by one or more storage devices.

When a user initiates a mirror operation for a particular LUN, the IOV layer 110 may mirror the data and/or write the data to the respective local and/or remote destinations (e.g., the target array 114). In the case of a remote destination, the IOV layer 110 may transfer the I/O data remotely through a dedicated multi-protocol converter in the multi-protocol converter layer 112. The multi-protocol convert layer may mirror ports to a similar remote intelligent SAS switch. The IOV layer 110 may write data to the target array 106 connected to the SAS switch 104. In one example, the switch 104 may be a remote intelligent SAS switch.

Referring to FIG. 2, a block diagram of the SAS switch 104 is shown. The switch 104 generally comprises a block (or circuit) 120 and a block (or circuit) 122. The block 120 may be implemented as a local port section. The block 122 may be implemented as a multi-protocol port section. The block 120 generally comprises a number of ports 130a-130n. The block 122 generally comprises a number of ports 132a-132n. The ports 130a-130n and/or 132a-132n may be implemented as remote mirror ports. The ports 130a-130n and/or 132a-132n may be capable of multi-protocol routing. As soon as the device is powered on, the SAS switch 104 may discover all the hosts and SAS storage array (targets) attached to the switch 104. The IOV layer 110 in the switch 104 may present virtual targets to the host/initiator 102 and/or virtual initiators to the SAS storage array (e.g., targets) 106. The IOV layer 110 may present virtual targets and associated LUNs 114 to the host 102. In one example, the SAS storage array 106 may be connected locally to the SAS switch 104. In another example, a remote SAS storage array 106 may connect to the SAS switch 104 through a number of ports (e.g., ports 130a-130n and 132a-132n). In one example, the ports may be implemented as Multi Protocol Converter (MPC) ports, SAS ports, FC ports and/or iSCSI ports. However, other types of ports may be implemented depending on the design criteria of a particular implementation. The IOV layer 110 may be presented as a virtual initiator to the storage array 106.

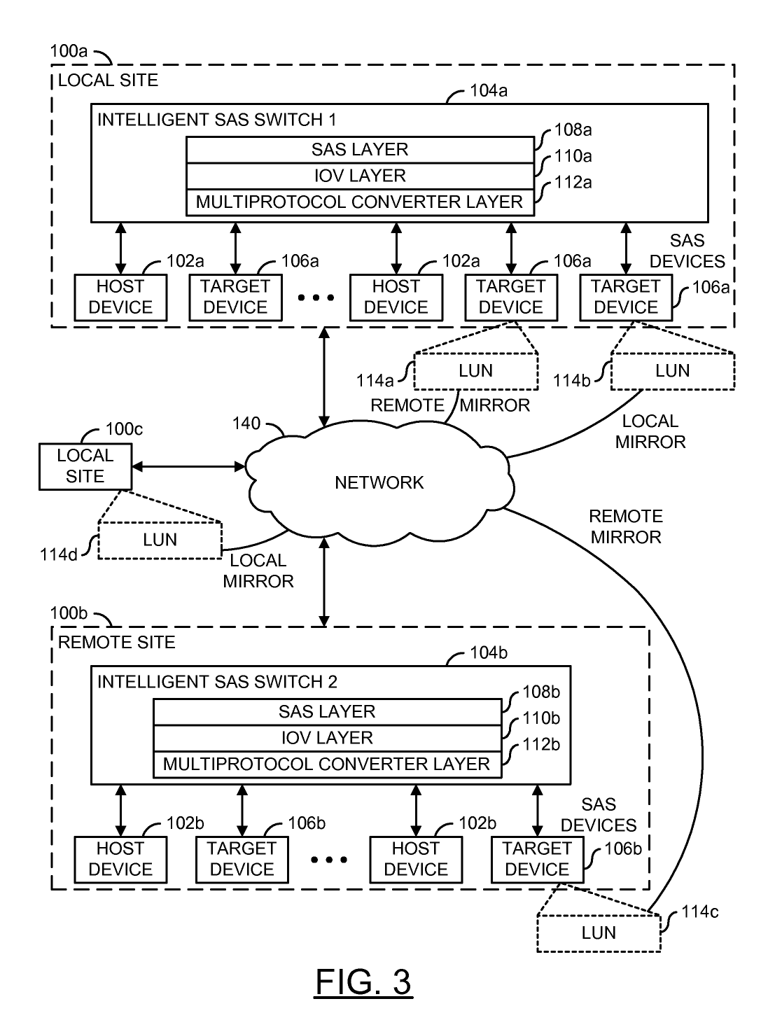

Referring to FIG. 3, a block diagram of a context of the present invention is shown. An LUN list may be received from different SAS arrays (e.g., the target device 106a and/or the target device 106b) connected to the SAS switch 104. The LUNs 114a-d may be mapped from the virtual target to the actual initiator. LUN mirroring may be implemented via the network 140. The mirroring may be local or distributed (e.g., remote). In one example, LUN mirroring may be implemented using multi-protocol routing. The host 102 and/or the target 106 may be connected to the switch 104. Local devices (e.g., located in the local site 100a and/or 100b) may be connected to local switches. Remote devices (e.g., located in the remote site 100b) may be connected to remote switches. The remote LUN (e.g., the LUN 114c) may be locally available by implementing multi-protocol routing. The local LUN (e.g., the LUN 114a, 114b, and/or 114d) may be available over the network 140.

A number of I/O blocks may be mirrored by the IOV layer 110 before being written to the SAS physical targets (e.g., target devices 106a and/or 106b). The mirrored I/O blocks may be written to a local SAS target array 106a (located in the local site 100a and/or 100c) or a remote SAS target array 106b (e.g., located in the local site 100b). To implement a remote SAS array mirror, the IOV layer 110 may use the multi-protocol converter layer 112. Multi-protocol routing may be performed by encapsulating the SAS I/O data frames in fiber channel (FC), Internet Small Computer System Interface (iSCSI), and/or other protocol implemented for a respective network. The ports 130a-130n and/or 132a-132n in the SAS switch 104 may support one or more specific protocols. The encapsulated frames may be received at the remote intelligent SAS switch 104b. The encapsulated frames may be de-capsulated and written to the remote target SAS array 106b.

The IOV layer 110 may present the ports 130a-130n and 132a-132n on the intelligent SAS switch 104 as initiator ports. The storage array 106 may map the ports 130a-130n and 132a-132n as virtual initiator ports in the storage management software. The LUN 114 from the storage array 106 may be mapped to the virtual initiator ports 130a-130n and 132a-132n. The IOV layer 110 may also determine the unique array identifier (UAID) while discovering the LUN 114 through regular SCSI commands. The IOV layer 110 may comprise a list of LUNs. The list of LUNs may be mapped to the virtual initiators from different storage arrays.

A corresponding virtual target identifier may be created for each virtual initiator identifier. The virtual target identifier may be generated by the IOV layer 110. The virtual target identifier may be based on the SAS address of the switch ports 130a-130n and/or 132a-132n connected to the initiators. The virtual target may presented to the actual initiators or the host/server 102. The IOV layer 110 on the intelligent SAS switch 104 may allow the LUN 114 to be available to the actual initiators using virtual target identifications. A user may configure the LUNs 114a-114d from the various targets to the initiators as required.

In one example, the LUNs 114a-114d may be from the same targets. In another example, the LUNs 114a-114d may be from remote SAS arrays. The target devices 106a and/or 106b may be mapped to the initiators 102a and/or 102b to allow communication between the target devices 106a and/or 106b and initiators 102a and/or 102b.

A routing table may be implemented to route the I/Os to the actual storage (e.g., target 106). The routing table may map the initiator 102 to the LUN 114 from a specific virtual storage array to/from the actual storage array UAID of the array. An example of the routing table may be implemented according to the following TABLE 1:

TABLE 1

| Initiator | Virtual target | | Virtual initiator | | |
|---|---|---|---|---|---|
| SAS address | [Generated by the | | [SAS address of | Array UAID | |
| [Actual | IOV layer for each | | switch port connected | [Actual SAS | |
| initiator] | virtual initiator] | LUN No. | to array] | target] | LUN No. |
| 50:06:05:b0:02: | LSI:EE:B3:34 | 7 | 50:06:05:b0:00: | 50:08:0e:51:b0: | 7 |
| 0b:67:40 | | | ee:b3:34 | 5a:e0:00 | |

TABLE 1 may be created when a user creates an initiator, virtual target and/or LUN mapping.

I/O data may be stripped to determine the source SAS address, the LUN number to which the I/O is being sent, and/or the virtual target identifier (e.g., the target SAS address) each time an I/O us received from the initiator 102. Once the IOV layer 110 has received the target identifier information, the IOV layer 110 may refer to the routing table and determine the mapping of the actual initiator to the virtual target, the virtual initiator, and/or the actual target. Once the route is determined, the I/O may be acknowledged. Each I/O data frame may be rerouted before I/O data reaches a physical disk on the target array 106. Such rerouting may minimize overhead when stripping each I/O data frame.

A similar process may be repeated when I/O returns from the target 106. The mapping of the actual target to the virtual initiator, the virtual target, and/or the actual initiator may be determined by the IOV layer 110.

Data may be mirrored on an LUN (e.g., the LUN 114a) to another LUN in the same array (e.g., the LUN 114b) or any other array on the network (e.g. the LUN 114d) using the mapping data. LUN mirroring may be implemented across the same storage array or a different storage array. The mirrored LUN generally comprises similar properties as the base LUN. A list of similar LUNs may be created based on the properties of the LUNs at the time of the initiator mapping. The LUNs 114a-114d may be made available from the same storage array, from different arrays in the same location, and/or in different locations. Remote volume mirroring may be implemented using the systems 100a-100c. The I/O blocks to the LUNs 114a, 114b, 114c and/or 114d may be mirrored by the IOV layer 110. The mirror I/O block may be written to the local and/or the remote SAS storage array (e.g., the target device 106b).

Redundancy may be maintained at one or more SAS switch levels. The switch 100a may be configured as a redundant switch for the switch 100b and/or the switch 100c. Disaster recovery of the local site 100a and/or 100b may be implemented through the remote site location 100b with an SAS storage array 106b. The switches 104a and/or 104b may provide high availability and/or high fault tolerance.

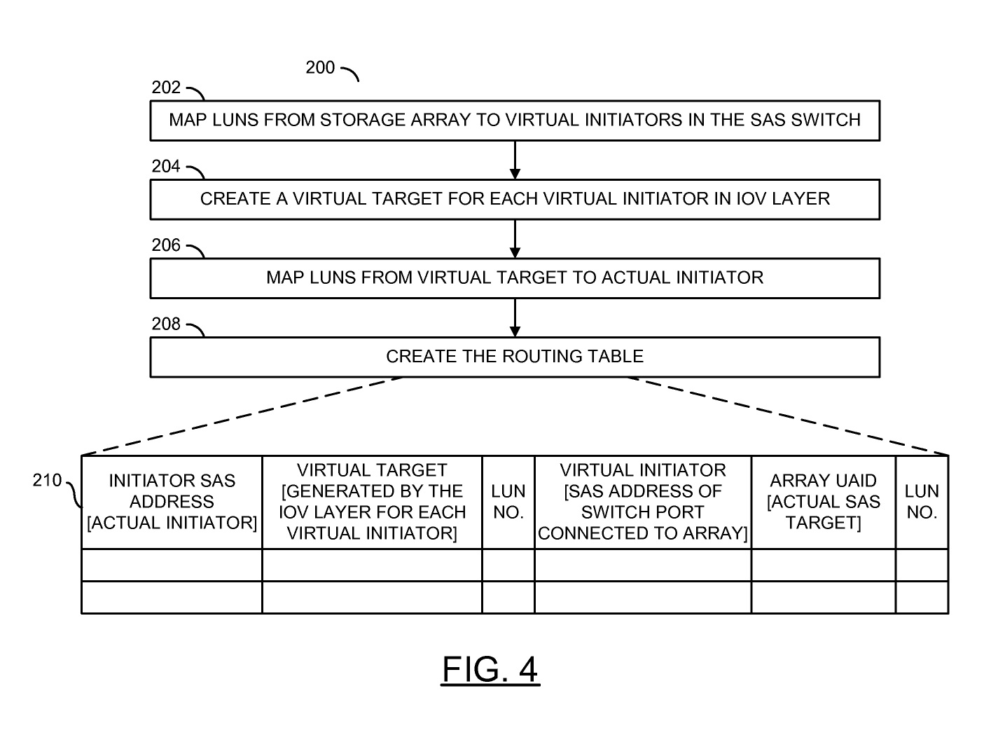

FIG. 4 illustrates a flow diagram for a method (or process) 200 illustrating the creation of the routing table. The method 200 generally comprises a step (or state) 202, a step (or state) 204, a step (or state) 206, a step (or state) 208, and a step (or state) 210. The step 202 may map the LUNs 114 from the storage array 106 to virtual initiators in the SAS switch 104. The step 204 may create a virtual target for each of the virtual initiators in the IOV layer 110. The step 206 may map the LUNs 114 from the virtual target to an actual initiator. The step 208 may create the routing table. The step 210 illustrates an example of the routing table.

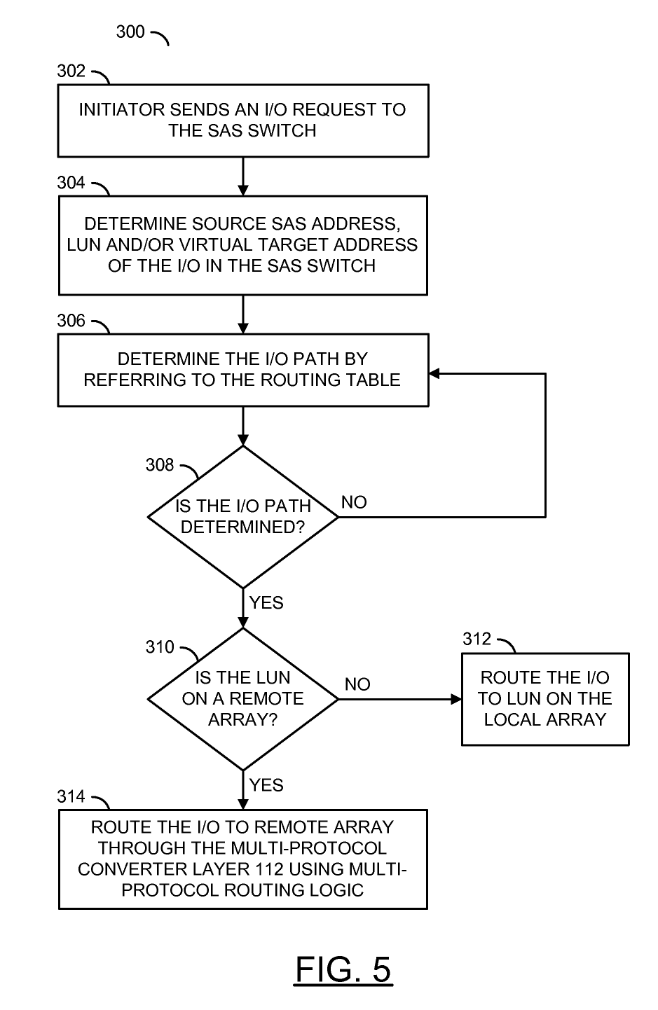

FIG. 5 illustrates a flow diagram for the method (or process) 300 of handling an input/output request. The method 300 generally comprises a step (or state) 302, a step (or state) 304, a step (or state) 306, a decision step (or state) 308, a decision step (or state) 310, a step (or state) 312, and a step (or state) 314. In the step 302, the initiator may send an I/O request to the SAS switch 104. The step 304 may determine a source SAS address, a LUN and/or a virtual target address of the I/O in the SAS switch 104. The step 306 may determine the I/O path by referring to the routing table. The decision state 308 may determine if the I/O path has been determined. If not, the method 300 moves back to the state 306. If so, the method 300 moves to the state 310. The state 310 may determine if the LUN is on a remote array. If not, the method 300 moves to the state 312. The state 312 may route the I/O to the LUN 114 on the local array. If the decision state 310 determines that the LUN 114 is on a remote array, the method 300 moves to the step 314. The step 314 may route the I/O to the remote array through the multi-protocol converter layer 112 using a multi-protocol routing logic.

A user may select an option for the remote SAS storage array target 106. The IOV layer 110 may encapsulate the I/O blocks to related protocols (e.g., FC, ISCSI, FCoE, etc.) using the multi-protocol ports 132a-132n. The ports 132a-132n may be dedicated mirror ports. The ports 132a-132n may de-capsulate the I/O block and write the mirror I/O blocks to the remote SAS storage array target 106.

The system 100 may implement a virtualized I/O path in the SAS switch 104. The same I/O path for the I/O block mirror may be utilized at the IOV layer 110. The multi-protocol ports 132a-132n may be implemented on the SAS switch 104 for remote intelligent SAS switch and/or SAS storage array discovery. The multi-protocol converter layer 112 may implement a remote volume/LUN mirror on the SAS storage array 106.

The functions performed by the diagrams of FIGS. 4 and 5 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMS (random access memories), EPROMs (electronically programmable ROMs), EEPROMs (electronically erasable ROMs), UVPROM (ultra-violet erasable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, storage and/or playback devices, video recording, storage and/or playback devices, game platforms, peripherals and/or multi-chip modules. Those skilled in the relevant art(s) would understand that the elements of the invention may be implemented in other types of devices to meet the criteria of a particular application.

While the invention has been particularly shown and described with reference to the preferred embodiments thereof, it will be understood by those skilled in the art that various changes in form and details may be made without departing from the scope of the invention.

1. An apparatus comprising:
a first switch comprising a first plurality of ports, wherein a first of said ports is connected to a first host device, a second of said ports is connected to a first target device, and a third of said ports is connected to a network, wherein said target device includes a first storage LUN; and
a second switch comprising a second plurality of ports, wherein a first of said ports is connected to a second host device, a second of said ports is connected to a second target device, and a third of said ports is connected to said network, wherein (i) said second target device includes a second storage LUN and (ii) said first storage LUN and said second storage LUN form a data mirror.

2. The apparatus according to claim 1, wherein said mirror is formed across said network.

3. The apparatus according to claim 1, wherein said first switch is located at a local site and said second switch is located at a remote site.

4. The apparatus according to claim 1, wherein said first plurality of ports and said second plurality of ports implement multi-protocol routing.

5. The apparatus according to claim 1, wherein said first switch and said second switch comprise a Serial Attached SCSI (SAS) switch.

6. The apparatus according to claim 1, wherein said first switch determines a unique array identifier (UAID) for said second storage LUN.

7. The apparatus according to claim 1, wherein said first switch and said second switch each comprise a routing table mapped to said first target device and said second target device.

8. The apparatus according to claim 1, wherein said second switch is configured as a redundant switch for said first switch.

9. The apparatus according to claim 1, wherein said first switch comprises an input/output virtualization (IOV) layer to read/write data to said first target device.

10. The apparatus according to claim 9, wherein said IOV layer is linked to said first target device through a hardware abstract layer.

11. An apparatus comprising:
means for connecting (i) a first plurality of ports to a first host device, (ii) a second of said ports to a first target device and (iii) a third of said ports to a network, wherein said first target device includes a first storage LUN; and
means for connecting (i) a second plurality of ports to a second host device, (ii) a second of said ports is connected to a second target device and (iii) a third of said ports is connected to said network, wherein (a) said second target device includes a second storage LUN and (b) said first storage LUN and said second storage LUN form a data mirror.

12. A method of implementing remote data mirroring using a virtualized input/output path in a SAS switch, comprising the steps of:
connecting (i) a first plurality of ports to a first host device, (ii) a second of said ports to a first target device and (iii) a third of said ports to a network, wherein said first target device includes a first storage LUN; and
connecting (i) a second plurality of ports to a second host device, (ii) a second of said ports is connected to a second target device and (iii) a third of said ports is connected to said network, wherein (a) said second target device includes a second storage LUN and (b) said first storage LUN and said second storage LUN form a data mirror.

13. The method according to claim 12, further comprising the step of:
determining a path between said first target LUN and said second target LUN.

14. The method according to claim 13, further comprising the step of:
routing said path to a local array.

15. The method according to claim 13, further comprising the step of:
routing said path to a remote array.
